(19) United States
(12) Patent Application Publication
(10) Pub. No.: US 2002/0132066 A1
(43) Pub. Date: Sep. 19, 2002

(54) Imitation golf ball with liquid filled globe with attachment for key chain or golf bag connector

(76) Inventor: Scott Alan Cary, Modesto, CA (US)

Correspondence Address: SCOTT A. CARY, 2812 WOODMONT CIRCLE, MODESTO, CA, 95355, US

(21) Appl. No.: 09/771,613

(22) Filed: Jan. 30, 2001

(51) Int. Cl. G09F 19/00

(52) U.S. Cl. 428/11; 428/7

(57) ABSTRACT

A thin, circular shell like ball in two parts joining around clear, liquid filled globe encasing cube. Said cube to have instrumental messages related to sport, said cube to be buoyant, said shell to have key chain attachment or golf bag connector.

### CROSS-REFERENCE TO RELATED APPLICATIONS

Not applicable.

### BACKGROUND

1. Field of Invention

This invention relates to the sports field, specifically the golf field, and more specifically the individual entertainment of the sport golfer and enthusiast.

2. Description of Prior Art

A key chain and golf ball design U.S. Pat. D 404,195 to Beals (1999) shown only as an imitation golf ball shaped container with attachment for key chain. This patent is of similar shape although offers no related properties.

U.S. Pat. No. 6,168,407 to Kasashima (2001) provides a mold for manufacturing golf balls with a dimple design. This is merely a method of manufacturing an actual golf ball to its true structure to bear a specific performance.

The magic 8 ball is a children's toy and it is a black ball with the appearance of a billiard 8 ball. It is approximately 13 inches in circumference.

No foreign patents were identified to be in anyway similar.

### OBJECTS AND ADVANTAGES

Accordingly, besides the objects and advantages of the imitation golf ball globe key chain described in my above patent, several advantages of the present invention are:

(a) to attach to ones golf bag for easy golf reference as an fascinating device to be used during golf play, were as a player can direct undue focus and attention away from technique, and play the game with less emphasis on detail;

(b) to provide amusement (golf oriented) with professional caddie advice quotes from said golf ball that people of all ages will refer to for fun, in all settings;

(c) to assist the new inexperienced golfer during play, with sensible messages allowing a more positive experience;

(d) to provide a lighter more whimsical side to such a serious sport of golf for all levels of play;

(e) to provide a larger, easier to hold object when fastened to ones keys.

(f) As a key chain attachment, by use as a visual aide, the golf ball design becomes a token and increases interest and awareness to the game of golf as a sport.

### DRAWING FIGURES

In the drawings, closely related figures are numbered differently to explain more completely.

FIG. 1A through FIG. 5 illustrate the assembling of the imitation golf ball.

FIG. 1A shows the upper body of the main shell with a circular opening.

FIG. 1B shows the lower body of the main shell with an attachment for the key chain rings on the left supporting side.

FIG. 2A shows the upper circular dome like cylinder, providing crystal-clear views of FIG. 3 enclosed inside.

FIG. 2B shows the lower circular base.

FIG. 4 shows a mount that supports FIG. 2B and attaches to the interior of FIG. 1B.

FIG. 6-A shows a top view of the lower body assembly with focus to the joint lines as means of adjoining to FIG. 6-B. FIG. 7-A represents the interlocking docking of FIG. 6-A.

FIG. 6-B shows an interior view of the upper body assembly with focus to the joint lines as means of adjoining to FIG. 6-A. FIG. 7-B represents the interlocking docking of FIG. 6-B.

FIG. 8 shows and model of a dimple pattern for the golf ball exterior texture design.

FIG. 9 shows upper and lower circular dome like cylinder with focus to the mounting lines and attachment similar to FIGS. 7-A and 7-B respectively.

FIG. 10-A shows a lateral view of the eight-sided cube that floats inside the globe as seen in FIG. 2-A and 2-B.

FIG. 10-B and 10-D shows two separate parts married together and interlocking.

FIG. 10-C shows an aerial view of the cube display.

FIG. 10-E shows four triangles folded and jointed to create one-half of the cube.

REFERENCE NUMERALS IN DRAWING

| 1-A | upper body of main shell |
|---|---|
| 1-B | lower body of main shell |
| 2-A | upper circular cylinder/dome |
| 2-B | lower circular cylinder/base |
| 3 | message cube |
| 4 | mount |
| 5 | key chain and attachment |
| 6 | upper/lower main shell housing |
| 7 | groove connector |
| 8 | dimple design |
| 9 | globe connection |
| 10 | cube shape |

### DETAILED DESCRIPTION OF THE INVENTION

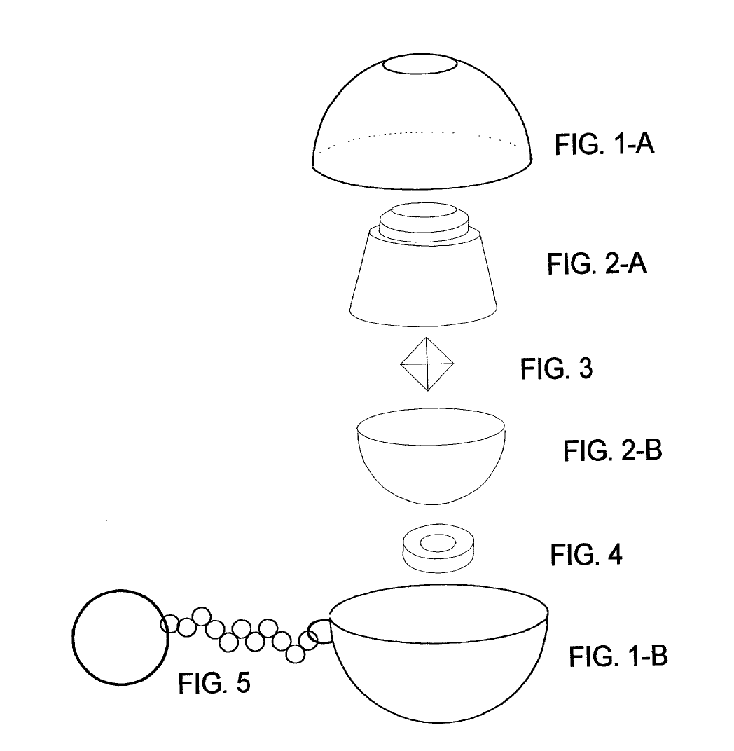

A preferred embodiment of this present invention is illustrated in FIG. 1-A side view (upper half) and figure 1-B side view (lower half), encasing FIGS. 2,3 and 4. The triangular, eight-sided cube (3 & 10-A) is viewed from within the clear circular domed globe (2-A) that is filled with a colored liquid. The said cube provides raised lettering that allows colored liquid to coat lightly, allowing the raised lettering to be decipherable. The liquid filled cylinder enclosing the cube (2-A, 2-B) allows the cube (3) to shift and move, floating freely. Said cube is made of thin buoyant plastic in a two part mold that connects (10-B, 10-D) with a male and female connector.

The circular domed globe (2-A, 2-B) is made of clear see through plastic in a two part mold. Said dome is glued together through interlocking groove connectors (7-A & 7-B). The mount (4) is a plastic buffer that holds the globe base (2-B) in position adding support to stabilize the globe as it is placed in the shell housing (1-A & 1-B). The round shape of the body is made in two parts, the upper half (1-A) provides a circular opening that is approximately one inch in diameter. This opening allows said domed globe to be viewed. The lower body (1-B) is the supporting half, furnishing said key chain attachment on the exterior of said body, and the placement buffer support (4) for said domed globe base. Said body resembles a golf ball in both size and dimple design (8), making it approximately 5 inches in circumference. Said body (1-A, 1-B) is connected together through interlocking groove connectors (7-A & 7-B), the units mount together securely, and is linked to a key chain designed for connecting to keys and/or a golfers golf bag.

Advantages

From the description above, an advantage of the imitation golf ball globe becomes evident;

(a) Said golf ball provides related golf advice to golfers or golf enthusiasts to bring a different flavor and enjoyment to the sport.

(b) As a sports theme said ball is referenced for decision making fun for the player or spectator.

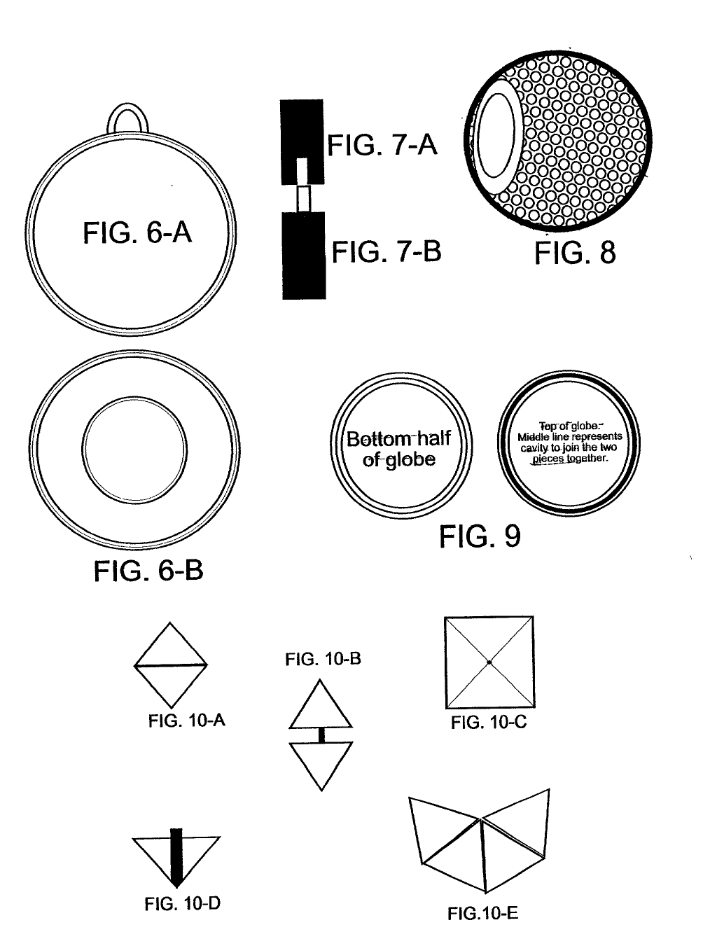

OPERATION—FIGS. 1-10

The imitation golf ball features a clear globe cylinder (2-A,2-B) that shows through the body of said golf ball (1-A) producing an eye with a floating cube (3). Said cube provides a clear message when held upright, allowing user to obtain informative golf related advice. Said ball provides an easy to hold design in both size and texture. When placed on a golfers golf bag it allows quick, easy reference to traditional golf decisions. When used as a key chain attachment said golf ball produces an improved handgrip.

Conclusion, Ramification, and Scope

Accordingly, the reader will see that the imitation golf ball and globe can be used for enjoyment while it can also be used for course management by supplying useful information during play of golf.

Although the description above contains only golf-related interests, these should not be construed as limiting the scope of the invention but as merely providing illustrations of some of the presently preferred embodiments of this invention. For example, the golf ball could have other shapes such as that of a football, basketball, or baseball shape; the cube with eight sides could be changed to as few as four sides or as many as twenty different sides; The grooves connecting the shell and globe may be modified to satisfy the manufacturer during production, etc.

Thus the scope of the invention should be determined by the appended claims and their legal equivalents, rather than by the examples given.

I claim:

1. An imitation ball comprising;
(a) a related shell with a circular hole and
(b) an interior clear globe raised level and viewable in a circular shape through said shell and
(c) a floating cube located within said globe providing related directions, marked in legible wording and
(d) a key chain attachment for connection to keys or golf bag.

2. The said shell of claim 1 wherein said body is composed of plastic and made from a two part mold.

3. The said globe of claim 1 wherein is composed of dear see through plastic with the crest of said globe slightly narrower in circumference than the lower lip permitting a tight hold when enclosed by said shell, also made from plastic an in two pieces.

4. The said cube of claim 1 wherein is composed of buoyant hallow plastic and connected together.

5. The said globe of claim 1 is filled with a fluid that is colored and floats said cube to the crest of said globe.

6. The said shell of claim 2 provides a similar texture and dimple design of an actual golf ball made by a mold.

7. The said shell of claim 1 provides an attachment for a key chain or golf bag with approximately ¼ of an inch high and 3/8 of an inch wide.
